(19) United States
(12) Patent Application Publication
(10) Pub. No.: US 2016/0207235 A1
(43) Pub. Date: Jul. 21, 2016

(54) ALUMINUM-BASED COMPOSITE MATERIAL AND METHOD OF MANUFACTURING THE SAME

(71) Applicant: KABUSHIKI KAISHA KAWAI GAKKI SEISAKUSHO, Hamamatsu-shi (JP)

(72) Inventors: Masaki Moriguchi, Hamamatsu-shi (JP); Shun Fujisawa, Hamamatsu-shi (JP)

(21) Appl. No.: 15/000,924

(22) Filed: Jan. 19, 2016

(30) Foreign Application Priority Data
Jan. 21, 2015 (JP) 009104/2015

(51) Int. Cl. B29C 45/14; B32B 15/20; B32B 27/30; B32B 15/08

(52) U.S. Cl. CPC B29C 45/14311; B32B 15/08; B32B 15/20; B32B 27/308; B32B 27/302; B29K 2055/02

(57) ABSTRACT

An inexpensive and high-quality aluminum-based composite material which can be obtained by securely joining a resin substrate formed of a predetermined kind of synthetic resin to an aluminum-based metal plate by a relatively simple method. The aluminum-based composite material includes the aluminum-based metal plate, the resin substrate, and a resin sheet formed of a synthetic resin which is of the same kind as the synthetic resin forming the resin substrate or has an affinity therefor and provided between the metal plate and the resin substrate. The resin substrate is joined to the metal plate by being injection-molded to the one side of the metal plate on which the resin sheet is provided.

### BACKGROUND OF THE INVENTION

1. Field of the Invention

The present invention relates to an aluminum-based composite material which is formed by joining a resin substrate formed of a predetermined kind of synthetic resin to an aluminum-based metal plate formed of aluminum or an alloy containing aluminum as a basic component, and is used for decoration of interior equipment for automotive vehicles, musical instruments, furniture, household electrical appliances, and so forth, as well as to a method of manufacturing the aluminum-based composite material.

2. Description of the Related Art

Conventionally, as an aluminum-based composite material formed by joining an aluminum-based metal plate and a synthetic resin to each other, there has been known one disclosed e.g. in Japanese Laid-Open Patent Publication (Kokai) No. 2014-28454. When manufacturing this aluminum-based composite material, first, the aluminum-based metal plate is subjected to AC electrolytic treatment under predetermined conditions, whereby a predetermined oxide film is formed on the surface of the metal plate. Then, the metal plate having the oxide film thereon is set in a predetermined mold, and a synthetic resin is injected into the mold. With this, it is possible to obtain the aluminum-based composite material having the synthetic resin joined to the surface of the metal plate.

Further, as synthetic resins each of which can be joined to the above-mentioned metal plate, there are mentioned many kinds of thermoplastic resins and thermosetting resins. Specifically, as the thermoplastic resins, there are mentioned polyolefin, polyvinyl chloride, polyester, polyamide, polyphenylene sulfide, aromatic polyether ketone, polystyrene, fluorine resins, acrylic resins, ABS resins, polycarbonate, and thermoplastic polyimide resins. Further, as the thermosetting resins, there are mentioned phenol resins, epoxy resins, melamine resins, urea resins, unsaturated polyester resins, alkyd resins, polyurethane, and thermosetting polyimide.

However, according to the method of manufacturing the aluminum-based composite material disclosed in Japanese Laid-Open Patent Publication (Kokai) No. 2014-28454, when forming the oxide film on the surface of the metal plate, the electrolytic treatment is required to be performed only after a lot of conditions, specifically, respective prescribed conditions of pH, temperature, and dissolved aluminum concentration of electrolytic solution, as well as frequency, current density, electrolysis time, etc. are satisfied. Therefore, the surface treatment of the metal plate in the process of manufacturing the aluminum-based composite material is complicated and requires much time and labor.

Further, in Japanese Laid-Open Patent Publication (Kokai) No. 2014-28454, many kinds of synthetic resins are mentioned as ones each of which can be joined to the aluminum-based metal plate. However, affinity for the metal plate varies with the kind of each synthetic resin, and therefore, depending on the kind of each synthetic resin, the degree of bonding thereof to the metal plate is different. In particular, although an ABS resin or the like is not only excellent in impact resistance, rigidity, and moldability, but also relatively inexpensive, it cannot be said that the ABS resin sufficiently ensures the strength and overall uniformity of bonding of the ABS resin to the aluminum-based metal plate which has been subjected to the conventional surface treatment mentioned above.

### SUMMARY OF THE INVENTION

It is an object of the present invention to provide an inexpensive and high-quality aluminum-based composite material which can be obtained by firmly joining a resin substrate formed of a synthetic resin of a predetermined kind to an aluminum-based metal plate by a relatively simple method, and a method of manufacturing the aluminum-based composite material.

To attain the above object, in a first aspect of the present invention, there is provided an aluminum-based composite material comprising an aluminum-based metal plate formed of aluminum or an alloy containing aluminum as a basic component, a resin substrate formed of a synthetic resin of a predetermined kind and provided on one side of the metal plate, and a resin sheet formed of a synthetic resin which is of the same kind as the synthetic resin forming the resin substrate or has an affinity for the synthetic resin forming the resin substrate, and provided between the metal plate and the resin substrate so as to join the metal plate and the resin substrate to each other, wherein the resin substrate is joined to the metal plate by causing the synthetic resin of the predetermined kind to be injection-molded to the one side of the metal plate on which the resin sheet is provided.

With the construction of the aluminum-based composite material according to the present invention, the resin substrate formed of the predetermined kind of synthetic resin is joined to the one side of the aluminum-based metal plate formed of aluminum or an alloy containing aluminum as a basic component via the resin sheet formed of a synthetic resin which is of the same kind as the synthetic resin forming the resin substrate or has an affinity for the synthetic resin forming the resin substrate. Thus, the resin sheet formed of the synthetic resin is interposed between the aluminum plate and the resin substrate, and therefore, bonding between the aluminum plate and the resin substrate can be more stably maintained than e.g. when a wooden member is interposed between the two, without being affected by an environment including ambient temperature and humidity under which the aluminum-based composite material is used, or by variations in vessels, thickness, surface conditions of the wooden member itself. Further, the resin substrate is joined to the metal plate by being injection-molded to the one side of the metal plate on which the resin sheet is provided. The resin substrate and the resin sheet are formed of the same kind of synthetic resin or of respective synthetic resins having affinity therebetween, and hence the affinity between the two in injection molding is high. This makes it possible to securely join the resin substrate to the aluminum plate.

Preferably, the resin substrate is formed of a synthetic resin containing an ABS resin.

In general, an ABS resin is relatively inexpensive and excellent in impact resistance, rigidity, and moldability, and therefore, by employing a synthetic resin containing an ABS resin having such characteristics as a material for the resin substrate, it is possible to obtain an inexpensive and good-quality aluminum-based composite material. Note that as the synthetic resin containing an ABS resin, a synthetic resin formed of an ABS resin alone can be adopted as a matter of course, and it is also possible to adopt PC/ABS and the like.

Preferably, the resin sheet is formed of an ABS resin or a synthetic resin having an affinity for the ABS resin.

With the construction of this preferred embodiment, it is possible to obtain an inexpensive and good-quality aluminum-based composite material by adopting an ABS resin or a synthetic resin having an affinity for the ABS resin, as the material for the resin sheet.

To attain the above object, in a second aspect of the present invention, there is provided a method of manufacturing an aluminum-based composite material comprising a metal plate-preparing step of preparing an aluminum-based metal plate formed of aluminum or an alloy containing aluminum as a basic component, a resin sheet-bonding step of bonding a resin sheet formed of a synthetic resin of a predetermined kind by heat and pressure to one side of the prepared metal plate, and a resin injection molding step of setting the metal plate having the resin sheet bonded thereto in a predetermined mold, and injecting a synthetic resin which is of the same kind as the synthetic resin forming the resin sheet or has an affinity for the synthetic resin forming the resin sheet, into the mold, to thereby mold a resin substrate formed of the synthetic resin into a state joined to the one side of the metal plate.

With the configuration of the method of manufacturing an aluminum-based composite material, the aluminum-based metal plate is prepared, and the resin sheet formed of the synthetic resin of the predetermined kind is bonded by heat and pressure to the one side of the prepared metal plate. In general, the step of bonding by heat and pressure can be performed while applying heat and pressure uniformly to the whole resin sheet, which makes it possible to bond the whole resin sheet securely and uniformly to the aluminum plate. Then, the metal plate having the resin sheet bonded thereto is set in the predetermined mold, and a synthetic resin which is of the same kind as the synthetic resin forming the resin sheet or has an affinity therefor is injected into the mold. Since the synthetic resin injected into the mold is in a very hot molten state, by bringing the synthetic resin into contact with the resin sheet of the same kind or having an affinity therefor, the synthetic resin and the resin sheet are made integral with each other in a fused manner. As a consequence, by the injected synthetic resin, the resin substrate made of the synthetic resin of the same kind can be joined uniformly and firmly to the aluminum plate. As described above, according to the manufacturing method of the present embodiment, by a relatively simple method in which the resin sheet is bonded by heat and pressure to the aluminum plate before injecting a synthetic resin into a mold, it is possible to obtain a high-quality aluminum-based composite material in which the resin substrate is uniformly and firmly joined to the aluminum plate.

Preferably, the resin substrate is formed of a synthetic resin containing an ABS resin.

With the configuration of this preferred embodiment, by adopting a synthetic resin containing an ABS resin as a material for the resin substrate, it is possible to obtain an inexpensive and good-quality aluminum-based composite material, similar to the preferred embodiment described hereinbefore.

Preferably, the resin sheet is formed of an ABS resin or a synthetic resin having an affinity for the ABS resin.

With the configuration of this preferred embodiment, by adopting an ABS resin or a synthetic resin having an affinity for the ABS resin, as the material for the resin sheet, it is possible to obtain an inexpensive and good-quality aluminum-based composite material, similar to the preferred embodiment described hereinbefore.

The above and other objects, features, and advantages of the present invention will become more apparent from the following detailed description taken in conjunction with the accompanying drawings.

### BRIEF DESCRIPTION OF THE DRAWINGS

FIG. 1A is a front view of an automobile interior panel to which is applied an aluminum-based composite material according to an embodiment of the present invention;

FIG. 1B is a cross-sectional view taken on line A-A of FIG. 1A;

FIGS. 2A to 2D are views illustrating sequential steps of a method of manufacturing the interior panel shown in FIGS. 1A and 1B; and

FIGS. 3A to 3C are views illustrating a continuation of the manufacturing method shown in FIGS. 2A to 2D.

### DETAILED DESCRIPTION OF PREFERRED EMBODIMENTS

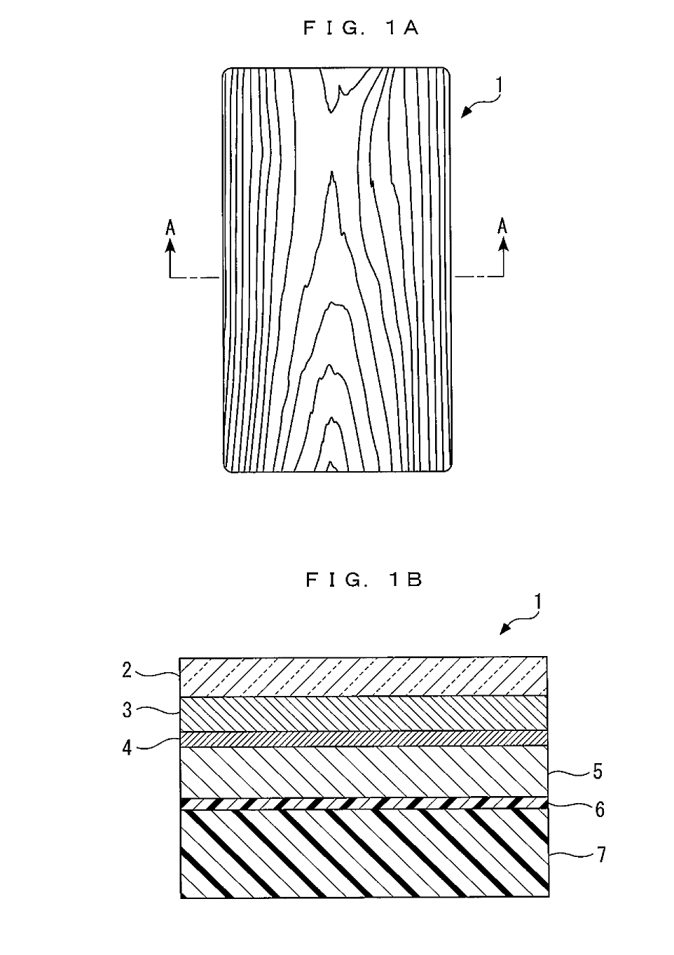

The present invention will now be described in detail with reference to the drawings showing a preferred embodiment thereof. FIGS. 1A and 1B show an aluminum-based composite material according to the embodiment of the present invention. FIG. 1A is a front view of the aluminum-based composite material, and FIG. 1B is a cross-sectional view of the same. As shown in FIGS. 1A and 1B, the aluminum-based composite material 1 has a rectangular shape as viewed from the front thereof, and has a top coat layer 2, a wooden decorative plate 3, an adhesive layer 4, an aluminum plate 5 (metal plate), a resin sheet 6, and a resin substrate 7, which are integrally laminated one upon another in the mentioned order from the front side (top side as viewed in FIG. 1B). In other words, the top coat layer 2, the wooden decorative plate 3, and the adhesive layer 4 are provided on the front side of the aluminum plate 5, while the resin sheet 6 and the resin substrate 7 are provided on the back side of the same.

The aluminum plate 5 is formed of aluminum or an alloy containing aluminum as a basic component, and has a rectangular shape, as viewed from the front thereof, with a predetermined thickness which is relatively small (e.g. 0.1 to 1.0 mm).

The wooden decorative plate 3 provided on the front side of the aluminum plate 5 is made of sliced veneer formed by slicing solid wood of maple, walnut, or the like, and has a grain pattern unique to natural wood. The wooden decorative plate 3 is bonded to the front side of the aluminum plate 5 via the adhesive layer 4 formed of a phenolic resin-impregnated sheet.

The top coat layer 2 is formed by a coating of a transparent resin, such as polyester or polyurethane. The transparent resin is applied to the front side of the wooden decorative plate 3 to form the coating, which protects the wooden decorative plate 3 while maintaining the appearance of the same.

On the other hand, each of the resin sheet 6 and the resin substrate 7 provided on the back side of the aluminum plate 5 is formed of an ABS resin. The resin sheet 6 is formed into a sheet shape having a predetermined thickness which is very thin (e.g. 0.15 to 0.25 mm). The resin sheet 6 is interposed between the aluminum plate 5 and the injection-molded resin substrate 7, whereby it plays a role of firmly joining the aluminum plate 5 and the resin substrate 7 to each other, as described hereinafter.

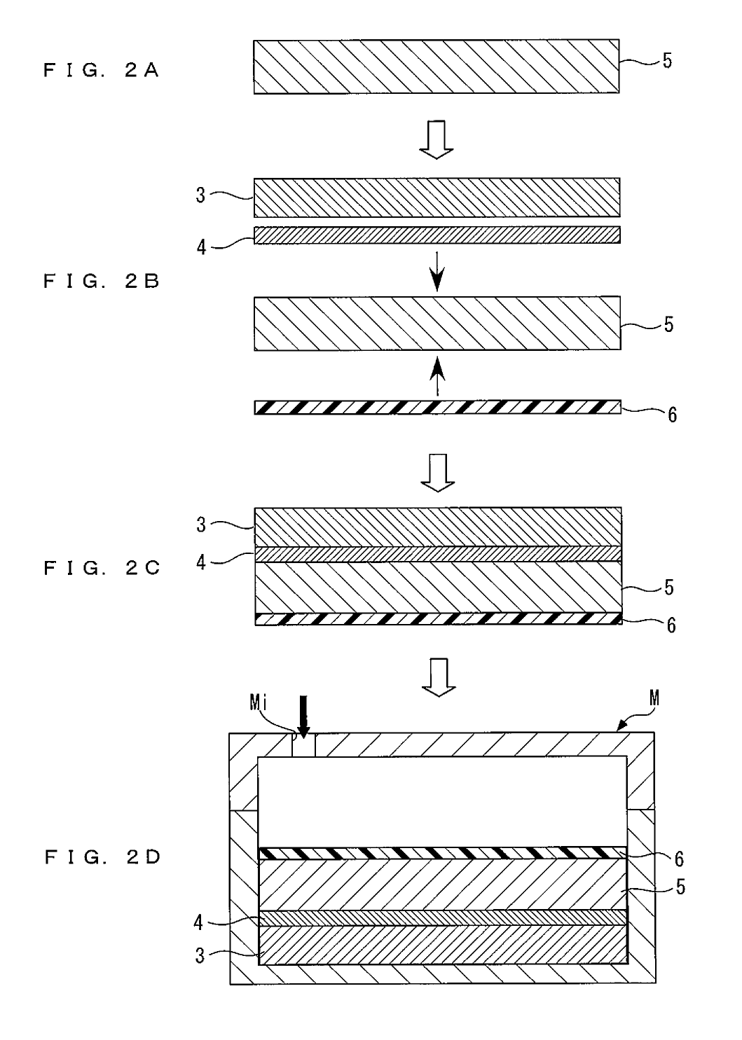

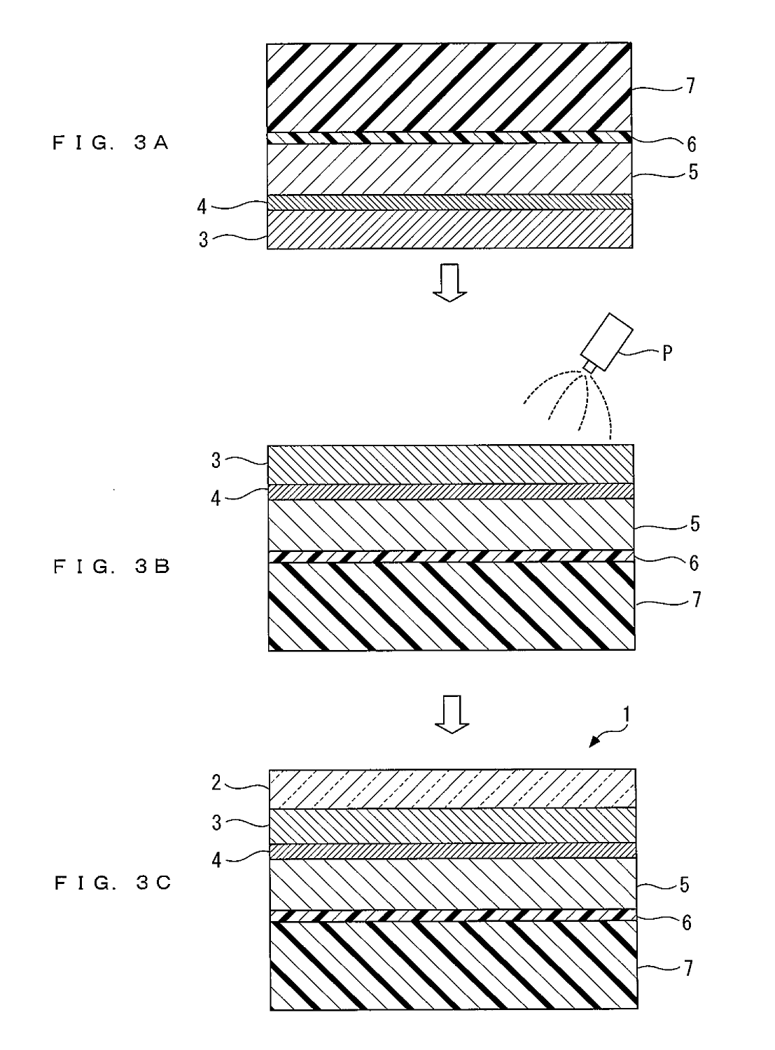

Next, a method of manufacturing the aluminum-based composite material 1 will be described with reference to FIGS. 2A to 2D and 3A to 3C. First, as shown in FIG. 2A, according to the shape and size of the aluminum-based composite material 1 to be manufactured, the rectangular aluminum plate 5 having the above-mentioned thickness is prepared (metal plate-preparing step). In this case, surface treatment by electrolysis or immersion may be performed on the aluminum plate 5. With this, oxide films having a large number of fine recesses are formed on the front and back sides of the aluminum plate 5. Further, the wooden decorative plate 3, the adhesive layer 4, and the resin sheet 6 each formed into a rectangular shape having the same size as that of the aluminum plate 5 are prepared.

Then, as shown in FIGS. 2B and 2C, the wooden decorative plate 3 is bonded by heat and pressure to the front side (upper side, as viewed in FIG. 2B) of the aluminum plate 5 via the adhesive layer 4, and the resin sheet 6 is bonded by heat and pressure to the back side (lower side, as viewed in FIG. 2B) of the aluminum plate 5 (resin sheet-bonding step). In these steps of bonding by heat and pressure, the members to be bonded to each other are superposed one upon another, and in this state, the wooden decorative plate 3 and the resin sheet 6 are bonded to the front and back sides of the aluminum plate 5, respectively, using a hot press machine, not shown, under predetermined conditions (e.g. a temperature of 120 to 150° C., a pressure of 120 to 150 kgf/cm², and press time of 5 to 15 minutes). In doing this, the bonding step can be carried out while applying heat and pressure uniformly to the whole wooden decorative plate 3 and the whole resin sheet 6, which makes it possible to securely bond the wooden decorative plate 3 and the resin sheet 6 to the front and back sides of the aluminum plate 5, respectively. Note that the wooden decorative plate 3 and the resin sheet 6 may be sequentially bonded to the front and back sides of the aluminum plate 5, respectively, or alternatively, the two members 3 and 6 may be simultaneously bonded to the aluminum plate 5.

Then, as shown in FIG. 2D, the aluminum plate 5 having the wooden decorative plate 3 and the resin sheet 6 bonded thereto is set in a mold M, whereafter molten ABS resin is injected by a predetermined pressure toward the back side, i.e. a side of the aluminum plate 5 toward the resin sheet 6 via an injection port Mi of the mold M, and is then cooled to be cured, whereby the resin substrate 7 is molded (resin injection molding step). During injection in this step, the ABS resin in a very hot molten state is brought into contact with the resin sheet 6 made of an ABS resin, whereby the injected ABS resin is made integral with the resin sheet 6 in a fused manner. Further to this, the resin sheet 6 is much smaller in volume than the injected ABS resin, and hence the amount of contraction thereof in cooling is very small, which makes it possible to excellently maintain firm bonding of the resin sheet 6 to the aluminum plate 5.

Then, a molded article including the injection-molded resin substrate 7 (see FIG. 3A) is taken out from the mold M, and a transparent synthetic resin (e.g. polyester or polyurethane) is applied to the entire surface of the wooden decorative plate 3 for top coating, using a coating machine P, as shown in FIG. 3B. As a consequence, the top coat layer 2 is formed on the surface of the wooden decorative plate 3, as shown in FIG. 3C, and this completes the manufacturing of the aluminum-based composite material 1.

As described in detail heretofore, according to the aluminum-based composite material 1 of the present embodiment, the resin substrate 7 formed of an ABS resin is joined to the back side of the aluminum plate 5 via the resin sheet 6 formed of the same kind of ABS resin. Thus, the resin sheet 6 formed of the ABS resin is interposed between the aluminum plate 5 and the resin substrate 7 made of the ABS resin, so that bonding between the aluminum plate 5 and the resin substrate 7 can be more stably maintained than e.g. when a wooden member is interposed between the two, without being affected by an environment including ambient temperature and humidity under which the aluminum-based composite material 1 is used, or by variations in vessels, thickness, surface conditions of the wooden member itself. Further, since the injection-molded resin substrate 7 and the resin sheet 6 are formed of the same kind of synthetic resin, the affinity between the two in injection molding is high, and hence it possible to securely join the resin substrate 7 to the aluminum plate 5.

Further, according to the method of manufacturing the aluminum-based composite material 1 of the present embodiment, the resin sheet 6 of the ABS resin is bonded by heat and pressure to the back side of the prepared aluminum plate 5. This step of bonding by heat and pressure can be performed while applying heat and pressure uniformly to the whole resin sheet 6, which makes it possible to bond the whole resin sheet 6 securely and uniformly to the aluminum plate 5. Furthermore, since the ABS resin injected into the mold M is in a very hot molten state, by bringing the ABS resin into contact with the resin sheet 6, the ABS resin and the resin sheet 6 are made integral with each other in a fused manner. As a consequence, by the injected ABS resin, the resin substrate 7 made of the same kind of ABS resin can be joined uniformly and firmly to the aluminum plate 5. As described above, according to the manufacturing method of the present embodiment, by the relatively simple method in which the resin sheet 6 is bonded by heat and pressure to the aluminum plate 5 before injecting an ABS resin into the mold M, it is possible not only to join the resin substrate 7 uniformly and firmly to the aluminum plate 5, but also to obtain an inexpensive and high-quality aluminum-based composite material 1.

Note that the present invention is not limited to the above-described embodiment, but can be practiced in various forms. Although in the present embodiment, as a synthetic resin forming the resin sheet 6 and the resin substrate 7, an ABS resin is used, by way of example, it is possible to adopt other appropriate kinds of synthetic resins. For example, as for the resin sheet 6, a synthetic resin having an affinity for the ABS resins, specifically PS (polystyrene), an AS resin, PC (polycarbonate), PMMA (polymethyl methacrylate) (acrylic resin), PBT (polybutylene terephthalate), or PPS (polyphenylene sulfide). On the other hand, as for the resin substrate 7, it is possible to adopt a synthetic resin containing an ABS resin, i.e. a resin material, such as PC/ABS, in which an ABS resin and another resin are mixed, for example.

Further, for example, in a case where a synthetic resin is directly injection-molded to an aluminum plate without using a resin sheet, when bonding between the aluminum plate and the molded resin substrate is insufficient, by performing the above-described manufacturing method using a resin sheet of a synthetic resin of the same kind, it is sometimes possible to obtain a high-quality aluminum-based composite material in which the aluminum plate and the resin substrate made of the synthetic resin are firmly joined to each other.

Further, the details of the construction of the aluminum-based composite material 1 and the details of the procedure and conditions of the manufacturing method described in the embodiment are given only by way of example, and various changes and modifications may be made without departing from the spirit and scope of the present invention.

What is claimed is:

1. An aluminum-based composite material comprising:
an aluminum-based metal plate formed of aluminum or an alloy containing aluminum as a basic component;
a resin substrate formed of a synthetic resin of a predetermined kind and provided on one side of said metal plate; and
a resin sheet formed of a synthetic resin which is of the same kind as the synthetic resin forming said resin substrate or has an affinity for the synthetic resin forming said resin substrate, and provided between said metal plate and said resin substrate so as to join said metal plate and said resin substrate to each other,
wherein said resin substrate is joined to said metal plate by causing the synthetic resin of the predetermined kind to be injection-molded to the one side of said metal plate on which said resin sheet is provided.

2. The aluminum-based composite material according to claim 1, wherein said resin substrate is formed of a synthetic resin containing an ABS resin.

3. The aluminum-based composite material according to claim 1, wherein said resin sheet is formed of an ABS resin or a synthetic resin having an affinity for the ABS resin.

4. The aluminum-based composite material according to claim 2, wherein said resin sheet is formed of the ABS resin or a synthetic resin having an affinity for the ABS resin.

5. A method of manufacturing an aluminum-based composite material comprising:
a metal plate-preparing step of preparing an aluminum-based metal plate formed of aluminum or an alloy containing aluminum as a basic component;
a resin sheet-bonding step of bonding a resin sheet formed of a synthetic resin of a predetermined kind by heat and pressure to one side of the prepared metal plate; and
a resin injection molding step of setting the metal plate having the resin sheet bonded thereto in a predetermined mold, and injecting a synthetic resin which is of the same kind as the synthetic resin forming the resin sheet or has an affinity for the synthetic resin forming the resin sheet, into the mold, to thereby mold a resin substrate formed of the synthetic resin into a state joined to the one side of the metal plate.

6. The method according to claim 5, wherein the resin substrate is formed of a synthetic resin containing an ABS resin.

7. The method according to claim 5, wherein the resin sheet is formed of an ABS resin or a synthetic resin having an affinity for the ABS resin.

8. The method according to claim 6, wherein the resin sheet is formed of the ABS resin or a synthetic resin having an affinity for the ABS resin.
